(19) United States
(12) Patent Application Publication
(10) Pub. No.: US 2026/0154624 A1
(43) Pub. Date: Jun. 4, 2026

(54) INTELLIGENT DATA INGESTION

(71) Applicant: ADP, Inc., Roseland, NJ (US)

(72) Inventors: Aravind Sundar, Bristol (GB); Naveen Baskaran, Chennai (IN); Rajkumar Selvaraj, Chennai (IN); Janarthanan Venu, Chennai (IN); Kavitha Pradeepkumar, Chennai (IN)

(73) Assignee: ADP, Inc., Roseland, NJ (US)

(21) Appl. No.: 19/465,775

(22) Filed: Jan. 30, 2026

Related U.S. Application Data
(63) Continuation of application No. 17/805,041, filed on Jun. 2, 2022, now Pat. No. 12,561,607.

(51) Int. Cl. G06N 20/00; G06F 16/22

(52) U.S. Cl. CPC G06N 20/00; G06F 16/221

(57) ABSTRACT

Intelligent data ingestion is provided. A determined column header name of a selected column in an imported data file is mapped to a predicted corresponding column header name of a particular column in a database corresponding to a human capital management application using a plurality of machine learning models. It is determined whether the predicted corresponding column header name output by each respective machine learning model of the plurality of machine learning models matches. In response to determining that the predicted corresponding column header name output by each respective machine learning model of the plurality of machine learning models does match, the predicted corresponding column header name of the particular column in the database is utilized as a target column name for the determined column header name of the selected column in the imported data file.

### CROSS-REFERENCES TO RELATED APPLICATIONS

This application claims benefit and priority under 35 U.S.C. § 120 as a continuation of U.S. patent application Ser. No. 17/805,041, filed Jun. 2, 2022, which is hereby incorporated by reference herein in its entirety.

### FIELD OF THE TECHNOLOGY

The disclosure relates generally to human capital management data and more specifically to intelligently ingesting client data into a database corresponding to a human capital management service provider using a plurality of machine learning models.

### BACKGROUND

Human capital management is the process of hiring appropriate people, managing workforces, and optimizing productivity. Human capital management has evolved from a mostly administrative function to an enabler of business value. Human capital management is made up of a series of administrative and strategic applications that include, for example, recruitment, onboarding, payroll, time and attendance, benefits and retirement services, talent management, training, reports, analytics, compliance, and the like. Human capital management can improve workforce productivity and help human resource managers hire, engage, and retain employees.

Most businesses are concerned with overcoming today's obstacles and anticipating tomorrow's needs. Human capital management can assist businesses in addressing these issues. For example, human capital management can identify opportunities throughout the employee lifecycle to engage employees and align employee performance with business goals.

### SUMMARY

According to one illustrative embodiment, a computer-implemented method for intelligent data ingestion is provided. The computer maps a determined column header name of a selected column in an imported data file to a predicted corresponding column header name of a particular column in a database corresponding to a human capital management application using a plurality of machine learning models. The computer determines whether the predicted corresponding column header name output by each respective machine learning model of the plurality of machine learning models matches. In response to the computer determining that the predicted corresponding column header name output by each respective machine learning model of the plurality of machine learning models does match, the computer utilizes the predicted corresponding column header name of the particular column in the database as a target column name for the determined column header name of the selected column in the imported data file.

According to another illustrative embodiment, a computer system for intelligent data ingestion. is provided. The computer system comprises a bus system, a storage device storing program instructions connected to the bus system, and a processor executing the program instructions connected to the bus system. The computer system maps a determined column header name of a selected column in an imported data file to a predicted corresponding column header name of a particular column in a database corresponding to a human capital management application using a plurality of machine learning models. The computer system determines whether the predicted corresponding column header name output by each respective machine learning model of the plurality of machine learning models matches. In response to the computer system determining that the predicted corresponding column header name output by each respective machine learning model of the plurality of machine learning models does match, the computer system utilizes the predicted corresponding column header name of the particular column in the database as a target column name for the determined column header name of the selected column in the imported data file.

According to another illustrative embodiment, a computer program product for intelligent data ingestion is provided. The computer program product comprises a computer readable storage medium having program instructions embodied therewith, the program instructions executable by a computer to cause the computer to perform a method. The computer maps a determined column header name of a selected column in an imported data file to a predicted corresponding column header name of a particular column in a database corresponding to a human capital management application using a plurality of machine learning models. The computer determines whether the predicted corresponding column header name output by each respective machine learning model of the plurality of machine learning models matches. In response to the computer determining that the predicted corresponding column header name output by each respective machine learning model of the plurality of machine learning models does match, the computer utilizes the predicted corresponding column header name of the particular column in the database as a target column name for the determined column header name of the selected column in the imported data file.

According to another illustrative embodiment, a method for intelligent data ingestion is provided. Determined column header names of a plurality of columns in an imported data file are mapped to predicted corresponding column header names of columns in a database using a plurality of machine learning models. It is determined whether the predicted corresponding column header names output by each machine learning model of the plurality of machine learning models match. In response to determining that the predicted corresponding column header names output by each machine learning model of the plurality of machine learning models do match, the predicted corresponding column header names of the columns in the database are utilized as target column names for the determined column header names of the plurality of columns in the imported data file.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented; and

FIGS. 3A-3C are a flowchart illustrating a process for intelligently ingesting client data in accordance with an illustrative embodiment.

### DETAILED DESCRIPTION

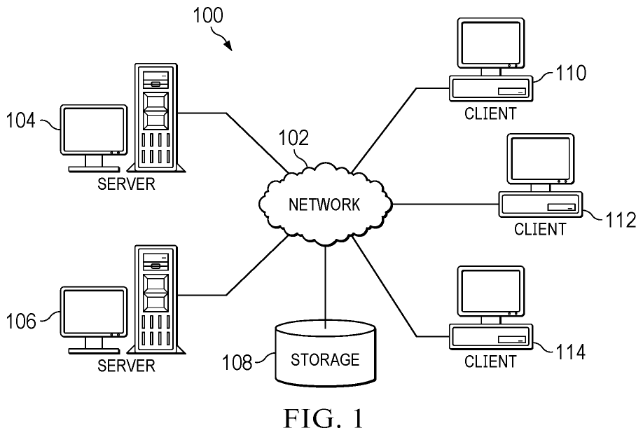

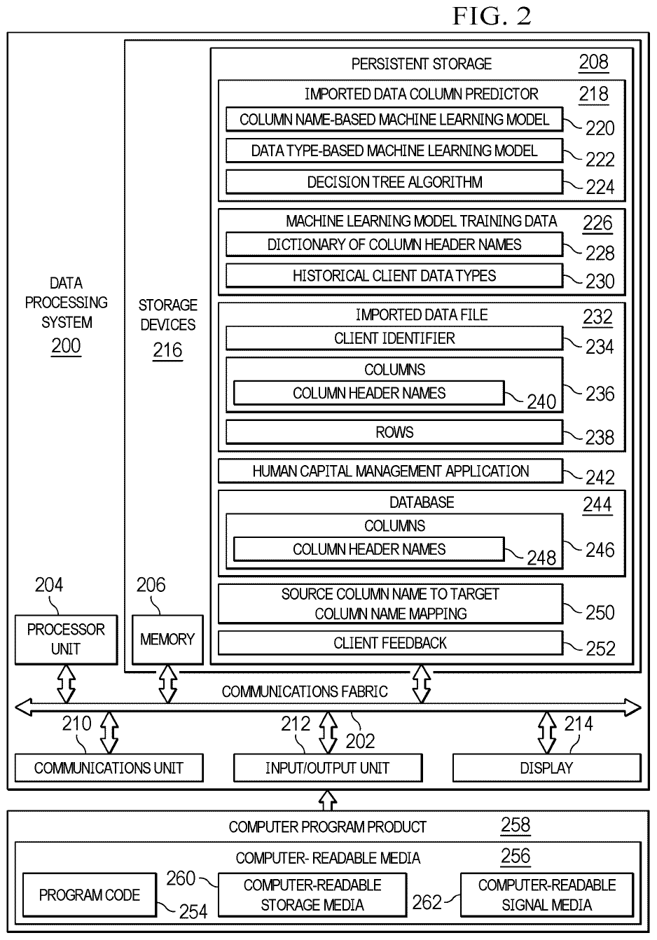

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. Also, server 104 and server 106 may each represent a cluster of servers in one or more data centers. Alternatively, server 104 and server 106 may each represent multiple computing nodes in one or more cloud environments.

In addition, server 104 and server 106 host a set of human capital management services provided by a human capital management service provider, such as, for example, Automatic Data Processing, Inc. of Roseland, New Jersey, to subscribing clients. Furthermore, server 104 and server 106 intelligently ingest data files imported by subscribing client device users into a database corresponding to the set of human capital management services using a plurality of trained machine learning models.

Machine learning is a concept of artificial intelligence. A machine learning model can learn without being explicitly programmed to do so. A machine learning model can learn based on training data input into the machine learning model. The machine learning model can learn using various types of machine learning algorithms. The machine learning algorithms can include at least one of a supervised learning, semi-supervised learning, unsupervised learning, feature learning, sparse dictionary learning, anomaly detection, association rules, or other types of learning algorithms. Examples of machine learning models include an artificial neural network, a decision tree, a support vector machine, a Bayesian network, and other types of models. These machine learning models can be trained using stored historical client data.

Client 110, client 112, and client 114 also connect to network 102. Clients 110, 112, and 114 are registered client devices of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, and the like, with wire or wireless communication links to network 102. Subscribing users of clients 110, 112, and 114 may utilize clients 110, 112, and 114 to access and utilize the human capital management services hosted by server 104 and server 106. Further, server 104 and server 106 may provide other information, such as, for example, applications, programs, files, data, and the like to clients 110, 112, and 114.

Storage 108 is a network storage device capable of storing any type of client data in a structured or relational format comprised of columns and rows. In addition, storage 108 may represent a plurality of network storage devices. Further, storage 108 may store identifiers and network addresses for a plurality of client devices, identifiers for a plurality of client device users, and the like. Furthermore, storage 108 may store other types of data, such as authentication or credential data that may include usernames, passwords, and the like associated with, for example, client device users, system administrators, security analysts, and the like. Moreover, subscribing users of clients 110, 112, and 114 may utilize clients 110, 112, and 114 to import their corresponding data files into server 104 and server 106 for intelligent ingestion and human capital management.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a wide area network, a metropolitan area network, a local area network, a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

With reference now to FIG. 2, a diagram of a data processing system is depicted in accordance with an illustrative embodiment. Data processing system 200 is an example of a computer, such as server 104 in FIG. 1, in which computer readable program code or instructions implementing the intelligent data ingestion processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer readable storage device or computer readable storage medium is any piece of hardware that is capable of storing information, such as, for example, without limitation, data, computer readable program instructions in functional form, and/or other suitable information either on a transient basis or a persistent basis. Further, a computer readable storage device or computer readable storage medium excludes a propagation medium, such as a transitory signal. Memory 206, in these examples, may be, for example, a random-access memory, or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores imported data column predictor 218. However, it should be noted that even though imported data column predictor 218 is illustrated as residing in persistent storage 208, in an alternative illustrative embodiment imported data column predictor 218 may be a separate component of data processing system 200. For example, imported data column predictor 218 may be a hardware component coupled to communication fabric 202 or a combination of hardware and software components. In another alternative illustrative embodiment, a first set of components of imported data column predictor 218 may be located in data processing system 200 and a second set of components of imported data column predictor 218 may be located in a second data processing system, such as, for example, server 106 in FIG. 1.

Imported data column predictor 218 controls the process of intelligently ingesting client data imported from any data source. In this example, imported data column predictor 218 includes column name-based machine learning model 220, data type-based machine learning model 222, and decision tree algorithm 224. Optionally, imported data column predictor 218 may include a column proximity-based machine learning model.

Imported data column predictor 218 utilizes column name-based machine learning model 220 to predict a corresponding column header name in a database corresponding to a human capital management application that matches a particular column header name of a given column in a client's imported data file. Imported data column predictor 218 utilizes data type-based machine learning model 222 to predict a corresponding data column header name for imported column data that has a pattern associated with it, such as, for example, an email address, mailing address, zip code, phone number, or the like. Imported data column predictor 218 utilizes decision tree algorithm 224, which is another machine learning model, to generate a decision tree for determining which particular machine learning model is more accurate at predicting an appropriate data column header name that corresponds to a column header name of a particular column in the imported data when an output of the machine learning models differ (i.e., the predicted corresponding column header names output by the machine learning models do not match). Imported data column predictor 218 may utilize the column proximity-based machine learning model to predict an appropriate data column header name when, for example, a particular column in the imported data file does not contain a header name by analyzing the column header names and corresponding row values adjacent to that particular column.

Machine learning model training data 226 represent datasets that imported data column predictor 218 utilizes to train column name-based machine learning model 220 and data type-based machine learning model 222. In this example, machine learning model training data 226 include dictionary of column header names 228 and historical client data types 230. Dictionary of column header names 228 includes a list of column header names captured from a plurality of previously imported clients' data files. Imported data column predictor 218 utilizes dictionary of column header names 228 to train column name-based machine learning model 220. Historical client data types 230 represent a list of a plurality of different data types captured from the plurality of previously imported clients' data files. Imported data column predictor 218 utilizes historical client data types 230 to train data type-based machine learning model 222.

Imported data file 232 represents a currently imported data file from a subscribing client. However, it should be noted that imported data file 232 may represent a plurality of different data files imported from a plurality of different subscribing clients. Imported data file 232 may include any type of data corresponding to any type of data domain associated with the client.

In this example, imported data file 232 includes client identifier 234. Client identifier 234 uniquely identifies the client entity corresponding to imported data file 232. It should be noted that the client entity is a subscribing client to the human capital management service hosted by data processing system 200. The client entity may be, for example, an enterprise, business, company, organization, institution, agency, or the like.

Imported data file 232 is comprised of columns 236. Columns 236 may include any number of columns. Columns 236 include rows 238. Rows 238 may include any number of rows. Each row of a particular column contains a data value entry corresponding to that particular column. Further, columns 236 include column header names 240. Each respective column header name of column header names 240 corresponds to a particular column in imported data file 232 and is descriptive of the type of data contained in that particular column.

Human capital management application 242 provides the human capital management services hosted by data processing system 200. It should be noted that imported data column predictor 218 may be a component of human capital management application 242 even though imported data column predictor 218 is illustrated separately in this example. Database 244 corresponds to human capital management application 242. Database 244 is comprised of columns 246. Columns 246 include column header names 248.

Human capital management application 242 utilizes imported data column predictor 218 to map column header names 248 of columns 246 in database 244 with column header names 240 of columns 236 in imported data file 232 based on the output of column name-based machine learning model 220 and data type-based machine learning model 222 after analyzing column header names 240 and column header names 248. Imported data column predictor 218 generates source column name to target column name mapping 250 based on the mapping between column header names 248 of columns 246 in database 244 and column header names 240 of columns 236 in imported data file 232.

Imported data column predictor 218 then sends source column name to target column name mapping 250 to the client entity associated with client identifier 234 for review and correction, if needed. If corrections to source column name to target column name mapping 250 are needed due to one or more inaccurate mappings, then the client entity sends client feedback 252, which contains a set of corrections for the one or more inaccurate mappings in source column name to target column name mapping 250. Imported data column predictor 218 saves client feedback 252 and utilizes client feedback to update machine learning model training data 226 for retraining column name-based machine learning model 220 and data type-based machine learning model 222 to increase their predictive accuracy for future imported client data files.

Further, imported data column predictor 218 may perform a data validation process using a set of predefined business rules to ensure data integrity prior to ingesting imported data file 232 into database 244. If no data validation errors are found during the data validation process, then imported data column predictor 218 ingests imported data file 232 into database 244 based on source column name to target column name mapping 250.

As a result, data processing system 200 operates as a special purpose computer system in which imported data column predictor 218 in data processing system 200 enables intelligent ingestion of client data. In particular, imported data column predictor 218 transforms data processing system 200 into a special purpose computer system as compared to currently available general computer systems that do not have imported data column predictor 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity, Bluetooth® technology, global system for mobile communications, code division multiple access, second-generation, third-generation, fourth-generation, fourth-generation long term evolution, long term evolution advanced, fifth-generation, or any other wireless communication technology or standard to establish a wireless communications link for data processing system 200. Bluetooth is a registered trademark of Bluetooth Sig, Inc., Kirkland, Washington.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 254 is located in a functional form on computer readable media 256 that is selectively removable and may be loaded onto or transferred to data processing system 200 for running by processor unit 204. Program code 254 and computer readable media 256 form computer program product 258. In one example, computer readable media 256 may be computer readable storage media 260 or computer readable signal media 262.

In these illustrative examples, computer readable storage media 260 is a physical or tangible storage device used to store program code 254 rather than a medium that propagates or transmits program code 254. In other words, computer readable storage media 260 exclude a propagation medium, such as transitory signals. Computer readable storage media 260 may include, for example, an optical or magnetic disc that is inserted or placed into a drive or other device that is part of persistent storage 208 for transfer onto a storage device, such as a hard drive, that is part of persistent storage 208. Computer readable storage media 260 also may take the form of a persistent storage, such as a hard drive, a thumb drive, or a flash memory that is connected to data processing system 200.

Alternatively, program code 254 may be transferred to data processing system 200 using computer readable signal media 262. Computer readable signal media 262 may be, for example, a propagated data signal containing program code 254. For example, computer readable signal media 262 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer readable media 256” can be singular or plural. For example, program code 254 can be located in computer readable media 256 in the form of a single storage device or system. In another example, program code 254 can be located in computer readable media 256 that is distributed in multiple data processing systems. In other words, some instructions in program code 254 can be located in one data processing system while other instructions in program code 254 can be located in one or more other data processing systems. For example, a portion of program code 254 can be located in computer readable media 256 in a server computer while another portion of program code 254 can be located in computer readable media 256 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 254.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Illustrative embodiments take into account that an intuitive human capital management application can increase workforce productivity and morale. Data of an intuitive human capital management application can power better business decisions from optimized schedules to competitive compensation packages. Also, an intuitive human capital management application can enable proactive approaches to changing regulations to maintain compliance in an environment where compliance regulations in countries around the world are increasing. Thus, global and local monitoring by an intuitive human capital management application can enable businesses to stay current with changing regulations for compliance. Further, an intuitive human capital management application can increase data security and privacy using multi-layered protection and security alerts to prevent data breaches and fraud.

Client on-boarding is a challenge for both clients and human capital management service providers. For example, clients can spend a significant amount of time and effort converting data from their previous human capital management service providers to a template supported by the current human capital management service provider. In addition, the current human capital management service provider can spend a significant amount of time and effort getting that client data setup in its human capital management system. Further, when the client is a small to medium-sized business, spending too much time on setting up client data may not provide sufficient returns for the provider.

Illustrative embodiments utilize machine learning models to understand the imported client data in a file during ingestion of that imported client data. As a result, illustrative embodiments enable the client, itself, to perform the data migration process. Furthermore, illustrative embodiments ensure that data integrity is not compromised by performing data validations prior to ingesting the migrated client data into a database corresponding to the human capital management service.

In response to a client uploading a data file, illustrative embodiments map the uploaded data to appropriate data columns in the database of the human capital management service using a plurality of machine learning models. Illustrative embodiments train one of the machine learning models using a dictionary of data column header names. Illustrative embodiments utilize this column header name-based machine learning model to predict the appropriate column header name in the database of the human capital management service that matches a given column header name in the client's data file. For example, illustrative embodiments may utilize the column header name-based machine learning model to predict a data column header name when a prediction may be difficult (e.g., when selecting between first name, last name, nickname, or the like).

Illustrative embodiments train another of the machine learning models using stored historical client data types (e.g., business names, email addresses, mailing addresses, postal or zip codes, phone numbers, and the like). Illustrative embodiments utilize this data type-based machine learning model to identify the type of data in a given data column of the client's data file. For example, illustrative embodiments may utilize the data type-based machine learning model to predict a data column header name when the client data has a pattern associated with it or has a constant or finite value associated with it (e.g., a business name, email address, mailing address, zip code, phone number, or the like). Illustrative embodiments may select a configurable number of rows (e.g., 10, 20, 30, or the like) from that particular column of the client's data file to analyze to identify the data type rather than analyzing all rows of that column in order to save computer resources and time.

Optionally, illustrative embodiments may utilize a column proximity-based machine learning model to predict a data column header name when, for example, a column does not include a header name. Illustrative embodiments may utilize this column proximity-based machine learning model to predict a data column header name related to a column that contains date values, Boolean values, or the like. The column proximity-based machine learning model works similar to how a human would predict a name of a particular column containing these types of values by examining other columns immediately adjacent to that particular column. For example, the column proximity-based machine learning model may analyze a configurable number of columns (e.g., their header names and corresponding data values) immediately adjacent to either side or both sides of a particular column not including a header name. The configurable number of columns may be, for example, one, two, three, or the like.

It should be noted that illustrative embodiments utilize supervised machine learning to train the machine learning models in these examples. However, alternative illustrative embodiments may utilize other types of machine learning algorithms, such as, for example, a semi-supervised or unsupervised machine learning algorithm, to train the machine learning models. Also, illustrative embodiment can continuously retrain the machine learning models using received and stored client feedback regarding data column mappings to update the training datasets of the machine learning models. By utilizing these trained machine learning models, illustrative embodiments increase the predictive accuracy of the computer and thereby increase performance of the computer, itself.

If the output of both the column name-based machine learning model and the data type-based machine learning model is the same for a particular data column of the client's data file (e.g., both models map to the same predicted corresponding data column in the database corresponding to the human capital management service), then illustrative embodiments determine that no conflict exists and utilize the predicted data column in the database corresponding to the human capital management service as the target data column for that particular data column of the client's data file. If the output of the column name-based machine learning model and the output of the data type-based machine learning model are different for a particular data column of the client's data file (e.g., both models map to different predicted data columns in the database corresponding to the human capital management service), then illustrative embodiments determine that a conflict exists and generate a decision tree to determine which machine learning model output is best to utilize for that particular data column of the client's data file. Illustrative embodiments generate the decision tree utilizing a supervised machine learning algorithm. Illustrative embodiments also generate an accuracy level (e.g., high, medium, or low) for the mapping output of each respective machine learning model corresponding to each respective data column of the client's data file.

Illustrative embodiments send the column mapping output of each respective machine learning model corresponding to each respective data column of the client's data file, along with the corresponding accuracy level of that particular column mapping, to the client for review prior to ingesting the client's data into the database corresponding to the human capital management service (e.g., a database corresponding to that particular client). Subsequently, illustrative embodiments receive an indication from the client as to whether changes to the current column mappings are needed or not. If the client indicates that no changes to the current column mappings are needed, then illustrative embodiments perform a data validation process on the client's data to ensure data integrity using a set of predefined business rules. If illustrative embodiments find one or more data validation errors during the data validation process, then illustrative embodiments send the data validation errors to the client for correction and rerun the data validation process upon receiving the corrections to the errors from the client. If illustrative embodiments do not find any data validation errors indicating no compromise to the data integrity while performing the data validation process, then illustrative embodiments ingest the client's data using the current column mappings predicted by the machine learning models.

If the client indicates that changes are needed to the current column mappings because one or more column header names are not mapped correctly, then illustrative embodiments wait to receive the changes to the current column mappings from the client prior to performing the validation process on the client's data. In response to receiving a set of modifications to the current column mappings from the client, illustrative embodiments store the client-modified column mappings for future machine learning model retraining to increase predictive accuracy of the machine learning models and perform the data validation process. In response to illustrative embodiments finding no data validation errors during the data validation process, illustrative embodiments ingest the client's data using the client-modified column mappings.

As a result, illustrative embodiments provide a data migration and ingestion process that enables a subscribing client to upload data files (e.g., human capital management reports) from previous service providers, irrespective of who the previous service providers are. Illustrative embodiments intelligently understand and ingest the uploaded data files from the subscribing client.

Thus, illustrative embodiments provide one or more technical solutions that overcome a technical problem with maintaining data integrity during data migration from data source to data target. As a result, these one or more technical solutions provide a technical effect and practical application in the field of data migration.

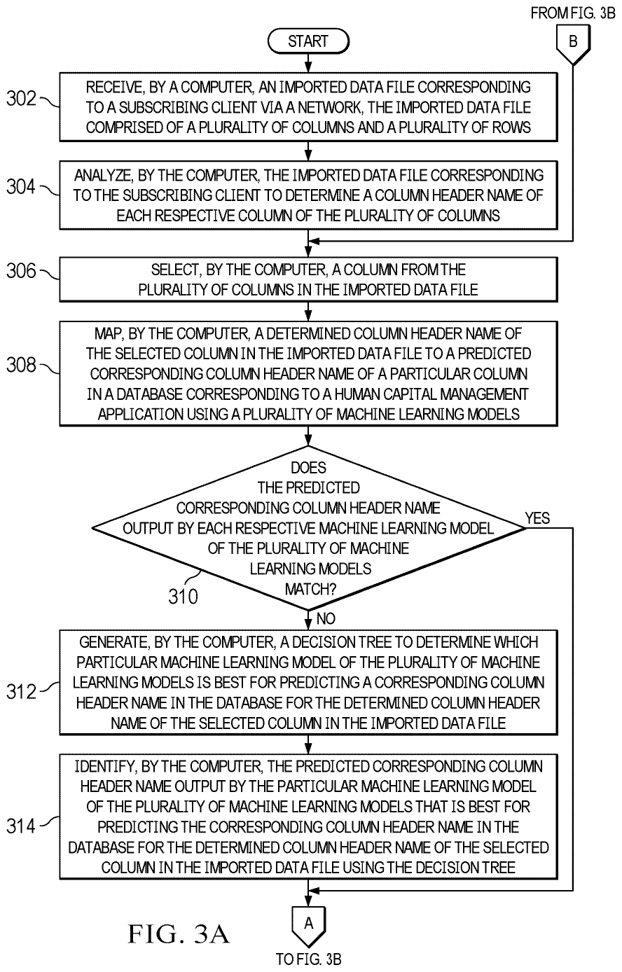

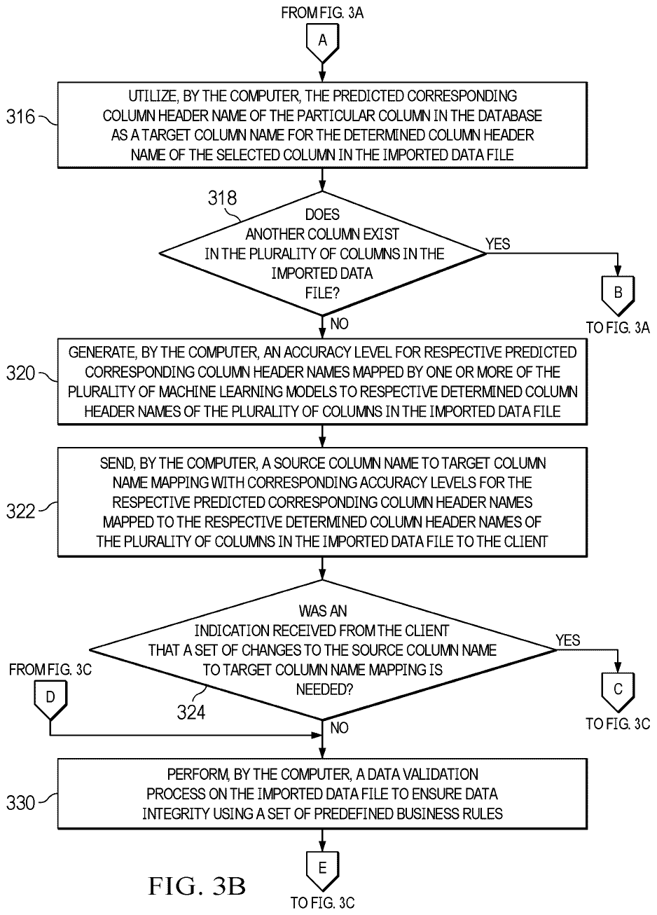

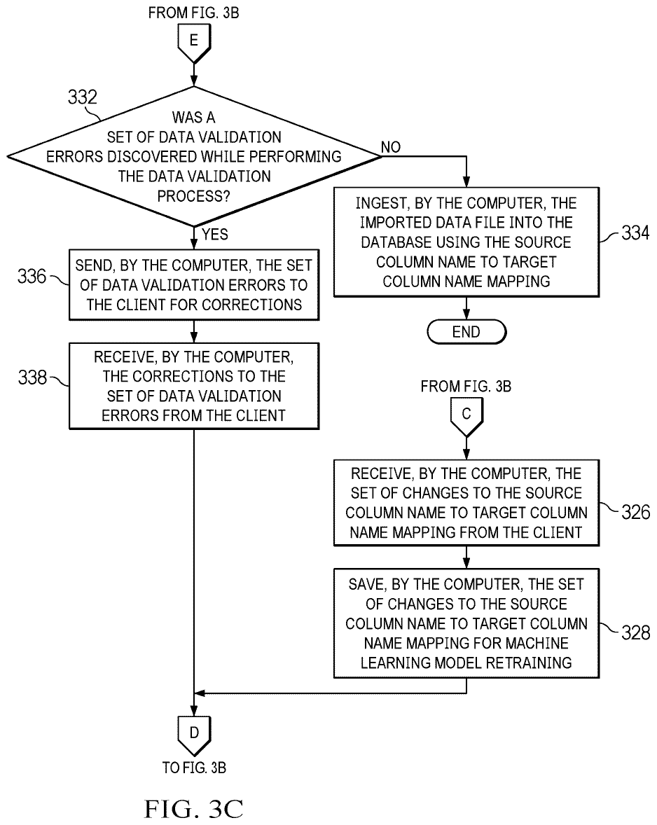

With reference now to FIGS. 3A-3C, a flowchart illustrating a process for intelligently ingesting client data is shown in accordance with an illustrative embodiment. The process shown in FIGS. 3A-3C may be implemented in a computer, such as, for example, server 104 in FIG. 1 or data processing system 200 in FIG. 2. For example, the process can be implemented in imported data column predictor 218 in FIG. 2.

The process begins when the computer receives an imported data file corresponding to a subscribing client via a network (step 302). The imported data file is comprised of a plurality of columns and a plurality of rows, such as, for example, in a relational database, table, rectangular dataset, or the like. The computer analyzes the imported data file corresponding to the subscribing client to determine a column header name of each respective column of the plurality of columns (step 304). The computer may utilize, for example, natural language processing, parsing, or the like, to analyze the imported data file to determine the column header names.

Subsequently, the computer selects a column from the plurality of columns in the imported data file (step 306). The computer maps a determined column header name of the selected column in the imported data file to a predicted corresponding column header name of a particular column in a database corresponding to a human capital management application using a plurality of machine learning models (step 308). The plurality of machine learning models may include, for example, a column name-based machine learning model, a data type-based machine learning model, and optionally a column proximity-based machine learning model.

Afterward, the computer makes a determination as to whether the predicted corresponding column header name output by each respective machine learning model of the plurality of machine learning models matches (step 310). If the computer determines that the predicted corresponding column header name output by each respective machine learning model of the plurality of machine learning models does match, yes output of step 310, then the process proceeds to step 316. If the computer determines that the predicted corresponding column header name output by each respective machine learning model of the plurality of machine learning models does not match, no output of step 310, then the computer generates a decision tree to determine which particular machine learning model of the plurality of machine learning models is best for predicting a corresponding column header name in the database corresponding to the human capital management application for the determined column header name of the selected column in the imported data file (step 312). The computer may utilize, for example, a decision tree algorithm to generate the decision tree. The decision tree algorithm is a supervised machine learning algorithm that continuously divides data based on a predefined set of rules until a final outcome is generated.

The computer identifies the predicted corresponding column header name output by the particular machine learning model of the plurality of machine learning models that is best for predicting the corresponding column header name in the database for the determined column header name of the selected column in the imported data file using the decision tree (step 314). The computer utilizes the predicted corresponding column header name of the particular column in the database as a target column name for the determined column header name of the selected column in the imported data file (step 316). The computer also makes a determination as to whether another column exists in the plurality of columns in the imported data file (step 318).

If the computer determines that another column does exist in the plurality of columns in the imported data file, yes output of step 318, then the process returns to step 306 where the computer selects another column in the imported data file. If the computer determines that another column does not exist in the plurality of columns in the imported data file, no output of step 318, then the computer generates an accuracy level for respective predicted corresponding column header names mapped by one or more of the plurality of machine learning models to respective determined column header names of the plurality of columns in the imported data file (step 320). In addition, the computer sends a source column name to target column name mapping with corresponding accuracy levels for the respective predicted corresponding column header names mapped to the respective determined column header names of the plurality of columns in the imported data file to the subscribing client via the network (step 322).

The computer makes a determination as to whether an indication was received from the subscribing client that a set of changes to the source column name to target column name mapping is needed due to one or more inaccurate source to target column name mappings (step 324). The computer may wait for a configurable amount of time to receive the indication from the subscribing client prior to proceeding to the next step. If the computer determines that an indication was received from the subscribing client that a set of changes to the source column name to target column name mapping is needed, yes output of step 324, then the computer receives the set of changes to the source column name to target column name mapping from the subscribing client via the network (step 326). Further, the computer saves the set of changes to the source column name to target column name mapping for machine learning model retraining (step 328). For example, the computer adds the set of changes to the source column name to target column name mapping to update machine learning model training data. Subsequently, the computer utilizes the updated machine learning model training data to retrain the plurality of machine learning models. Thereafter, the process proceeds to step 330.

Returning again to step 324, if the computer determines that an indication was not received from the subscribing client that a set of changes to the source column name to target column name mapping is needed, no output of step 324, then the computer performs a data validation process on the imported data file to ensure data integrity using a set of predefined business rules (step 330). The computer makes a determination as to whether a set of data validation errors was discovered while performing the data validation process (step 332).

If the computer determines that a set of data validation errors was not discovered while performing the data validation process, no output of step 332, then the computer ingests the imported data file into the database corresponding to the human capital management application using the source column name to target column name mapping (step 334). Thereafter, the process terminates. If the computer determines that a set of data validation errors was discovered while performing the data validation process, yes output of step 332, then the computer sends the set of data validation errors to the subscribing client for corrections (step 336). Subsequently, the computer receives the corrections to the set of data validation errors from the subscribing client (step 338). The computer incorporates the corrections to the set of data validation errors into the imported data file. Thereafter, the process returns to step 330 where the computer performs the data validation process on the imported data file once again.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

Thus, illustrative embodiments of the present invention provide a computer-implemented method, computer system, and computer program product for intelligently ingesting client data into a human capital management database. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
one or more processors, coupled with memory, to:
receive, via a network, a data file comprising a plurality of columns and a plurality of rows;
detect that a first column of the plurality of columns in the data file lacks a column header name;
determine an adjacency context for the first column that includes, for each of one or more columns adjacent to the first column, (i) a respective column header name and (ii) a descriptor of values in the one or more columns adjacent to the first column;
generate, with a proximity-based machine learning model, a target column name for the first column based on the adjacency context; and
ingest values of the first column into a database using the target column name as the column header name.

2. The system of claim 1, wherein the one or more processors further:
identify a configurable number of columns to use for the adjacency context; and
limit the adjacency context to the configurable number of columns.

3. The system of claim 2, wherein the adjacency context does not include columns outside a configurable number of columns.

4. The system of claim 1, wherein the one or more processors further:
generate, with the proximity-based machine learning model, the target column name based on relative positions of each of the one or more columns to the first column.

5. The system of claim 4, wherein the proximity-based machine learning model generates the target column name without using columns positioned outside a configurable number of columns relative to the first column.

6. The system of claim 1, wherein the one or more processors further:
determine the descriptor of values based on a pattern of types of values.

7. The system of claim 1, wherein the one or more processors further:
determine the descriptor of values based on a distribution of values.

8. The system of claim 1, wherein the one or more processors further:
generate an accuracy level for the target column name based on a score output by the proximity-based machine learning model.

9. The system of claim 1, wherein the one or more processors further:
transmit, prior to ingestion of the data file, the target column name and a corresponding accuracy level to a client device; and
receive, responsive to an interaction via an interface of the client device, approval to ingest the data file using the target column name.

10. The system of claim 1, wherein the one or more processors further:
receive, from a client device, feedback identifying a correction to the target column name; and
save the correction to the target column name for use in retraining the proximity-based machine learning model.

11. The system of claim 10, wherein the one or more processors further:
use the correction to the target column name to update the proximity-based machine learning model to improve accuracy levels associated with subsequently generated target column names.

12. The system of claim 1, wherein the one or more processors further:
perform a data validation process on the values of the first column using a set of predefined techniques prior to ingestion of the values into the database.

13. The system of claim 12, wherein the one or more processors further:
detect, pursuant to performance of the data validation process, an error;
transmit an indication of the error to a client device;
receive, from the client device, a correction to address the error; and
perform, subsequent to application of the correction, the data validation process on the values of the first column.

14. A method, comprising:
receiving, by one or more processors coupled with memory, via a network, a data file comprising a plurality of columns and a plurality of rows;
detecting, by the one or more processors, that a first column of the plurality of columns in the data file lacks a column header name;
determining, by the one or more processors, an adjacency context for the first column that includes, for each of one or more columns adjacent to the first column, (i) a respective column header name and (ii) a descriptor of values in the one or more columns adjacent to the first column;
generating, by the one or more processors, with a proximity-based machine learning model, a target column name for the first column based on the adjacency context; and
ingesting, by the one or more processors, values of the first column into a database using the target column name as the column header name.

15. The method of claim 14, comprising:
identifying, by the one or more processors, a configurable number of columns to use for the adjacency context; and
limiting, by the one or more processors, the adjacency context to the configurable number of columns.

16. The method of claim 14, comprising:
generating, by the one or more processors, with the proximity-based machine learning model, the target column name based on relative positions of each of the one or more columns to the first column.

17. The method of claim 14, comprising:
determining, by the one or more processors, the descriptor of values based on a pattern of types of values.

18. The method of claim 14, comprising:
generating, by the one or more processors, an accuracy level for the target column name based on a score output by the proximity-based machine learning model.

19. The method of claim 14, comprising:
transmitting, by the one or more processors, prior to ingestion of the data file, the target column name and a corresponding accuracy level to a client device; and
receiving, by the one or more processors, responsive to an interaction via an interface of the client device, approval to ingest the data file using the target column name.

20. A non-transitory computer-readable medium storing processor-executable instructions that, when executed by one or more processors, cause the one or more processors to:
receive, via a network, a data file comprising a plurality of columns and a plurality of rows;
detect that a first column of the plurality of columns in the data file lacks a column header name;
determine an adjacency context for the first column that includes, for each of one or more columns adjacent to the first column, (i) a respective column header name and (ii) a descriptor of values in the one or more columns adjacent to the first column;
generate, with a proximity-based machine learning model, a target column name for the first column based on the adjacency context; and
ingest values of the first column into a database using the target column name as the column header name.
